(19) United States
(12) Patent Application Publication
(10) Pub. No.: US 2012/0188470 A1
(43) Pub. Date: Jul. 26, 2012

(54) PROJECTION DISPLAY APPARATUS

(75) Inventor: Takaaki TANAKA, Osaka (JP)

(73) Assignee: PANASONIC CORPORATION, Osaka (JP)

(21) Appl. No.: 13/352,807

(22) Filed: Jan. 18, 2012

(30) Foreign Application Priority Data
Jan. 21, 2011 (JP) 2011-010391
Oct. 28, 2011 (JP) 2011-237558

(51) Int. Cl. G02F 1/1335

(52) U.S. Cl. 349/5

(57) ABSTRACT

A light valve forms image lights for the right and left eyes by time division and the polarization directions thereof are switched by a retardation panel, so as to be different in the image lights for the right and left eyes from each other, enabling observation of a stereoscopic image. A black-insertion unit is configured with a black-insertion liquid crystal panel and black-insertion polarizing elements, so as to insert light-shielding periods between the image lights for the right and left eyes. The black-insertion polarizing elements is moved between positions in a image light optical path and outside the optical path. Irrespective of the response speed of the light valve, a bright stereoscopic image with a small cross talk can be observed with passive system polarization glasses, with brightness of a two-dimensional image display being ensured.

### BACKGROUND OF THE INVENTION

1. Field of the Invention

The present invention relates to a projection display apparatus that irradiates an image formed on a light valve with illumination light, and magnifies and projects the image on a screen using a projection lens. In particular, the present invention relates to a projection display apparatus for stereoscopic image display.

2. Description of Related Art

For the purpose of obtaining a stereoscopic image display apparatus that is small and practical, it has been known that a single projection display apparatus using a liquid crystal panel as a light valve is driven by time division. In the case of a time-division drive, image lights for the right eye and for the left eye are formed by time division, which are observed with passive system polarization glasses by switching the polarization direction of the image light, or observed with active system liquid crystal shutter glasses.

FIG. 5 shows an example of a conventional projection display apparatus configured to switch the polarization direction of image light and to observe a stereoscopic image with passive system polarization glasses (JP 2005-65055 A). An optical system 61 for forming an image of blue, green and red color lights from the light of the source lamp 60 is formed of dichroic mirrors 62, 63 for color separation, reflection mirrors 64, 65, 66 and image formation liquid crystal panels 67r, 67g, 67b. The blue, green and red image lights from the liquid crystal panels 67r, 67g, 67b are combined by a combining prism 68, and projected by a projection lens 70 after passing through a polarization rotating liquid crystal 69. The polarization rotating liquid crystal 69 switches the polarization direction of the projected light between angles of 0° and 90°.

From the optical system 61, an image light for the right eye and an image light for the left eye of respective colors of blue, green and red are emitted alternatively for each field. At that time, the timing for emitting the green colored image lights for the right eye and for left eye is shifted by 1 field with respect to the timings for emitting the red and blue image lights for the right eye and for the left eye. Further, the polarization direction of the projected light from the combining prism 68 is switched by the polarization rotating liquid crystal 69 between angles of 0° and 90° for each field. Thereby, a stereoscopic image can be observed with polarization glasses.

However, since an image for the right eye and an image for the left eye are formed and switched for each field, cross talk can occur. That is, the image for the right eye can enter the left eye, and the image for the left eye can enter the right eye. Significant cross talk will make a double image. For reducing this cross talk, a high-speed responsiveness is required not only for the liquid crystal cell for the polarization-rotation control but similarly for the liquid crystal light valve for image formation. However, it is difficult to ensure a required high-speed responsiveness of not more than 5 msec in a TN mode liquid crystal or a VA mode liquid crystal of a practical light valve.

An example of display apparatuses using liquid crystal shutter glasses is disclosed in JP 2010-239474 A. In this apparatus, for solving the problem of insufficient response speed of the light valve for image formation, the light valve is driven at high speed (240 Hz for example), so that an image for the left eye and an image for the right eye are each repeated twice to form an image. And then, only one period of each image formed at the second time is transmitted through the liquid crystal shutter glasses. Thereby, it is possible to solve the problem of insufficient liquid crystal response speed in a case of using a liquid crystal panel and cross talk occurring due to insufficient contrast of the liquid crystal shutter of the shutter glasses.

In a conventional method of using active system liquid crystal shutter glasses, the cross talk will be reduced due to the high-speed drive of the image formation liquid crystal panel and also the control of the time for opening/closing the liquid crystal shutter glasses. However, the optical loss at the liquid crystal shutter glasses is considerable, and the brightness is decreased considerably by about 8% in comparison with the case of a two-dimensional image display. Furthermore, it causes some inconveniences. For example, the glasses are required to have a device for transmitting/receiving information with the display apparatus, and the glasses require charging or battery-exchange. In this manner, the method includes some problems such as the reduced brightness, cost rise, and the inferior convenience in comparison with passive system polarizing glasses.

### SUMMARY OF THE INVENTION

Therefore, with the foregoing in mind, it is an object of the present invention to provide a projection display apparatus configured to enable observation of a stereoscopic image by use of passive system polarization glasses, so that a bright stereoscopic image display is obtained with a considerably small cross talk irrespective of a use of a light valve having an insufficient response speed, and furthermore ensure sufficient brightness for a two-dimensional image display.

A projection display apparatus of the present invention includes: a light source; an illumination unit that condenses light from the light source so as to form illumination light; a light valve that receives the illumination light and forms an image light for the right eye and an image light for the left eye with time division; a retardation panel that switches polarization directions of the image light for the right eye and the image light for the left eye; and a projection lens that magnifies and projects the image lights. The projection display apparatus displays the image light for the right eye and the image light for the left eye while differentiating the polarization directions from each other so as to allow observation of a stereoscopic image.

For solving the above-mentioned problems, the projection display apparatus of the present invention further has a black-insertion unit that comprises a black insertion liquid crystal panel and black insertion polarizing elements arranged on the both sides of the black insertion liquid crystal panel and that is configured to be capable of inserting a light-shielding period between the image light for the right eye and the image light for the left eye by controlling the black insertion liquid crystal panel. And a movement control unit that moves at least the black insertion polarizing elements between a position in the optical path of the image light and a position outside the optical path.

The projection display apparatus having the above-mentioned configuration can provide a bright stereoscopic image display with considerably reduced cross talk and also a bright two-dimensional image display due to a black insertion liquid crystal panel provided with polarizing elements whose movement can be controlled along with a retardation panel.

### BRIEF DESCRIPTION OF THE DRAWINGS

FIG. 1 is a front view showing a configuration of a projection display apparatus according to Embodiment 1 of the present invention.

FIG. 2 is a perspective view showing an arrangement of a black insertion liquid crystal panel and a retardation panel in the projection display apparatus.

FIG. 3 includes diagrams for explaining operations of the black insertion liquid crystal panel and the retardation panel in the projection display apparatus.

FIG. 4 is a front view showing a configuration of a projection display apparatus according to Embodiment 2 of the present invention.

FIG. 5 is a front view showing an example of a configuration of a conventional projection display apparatus.

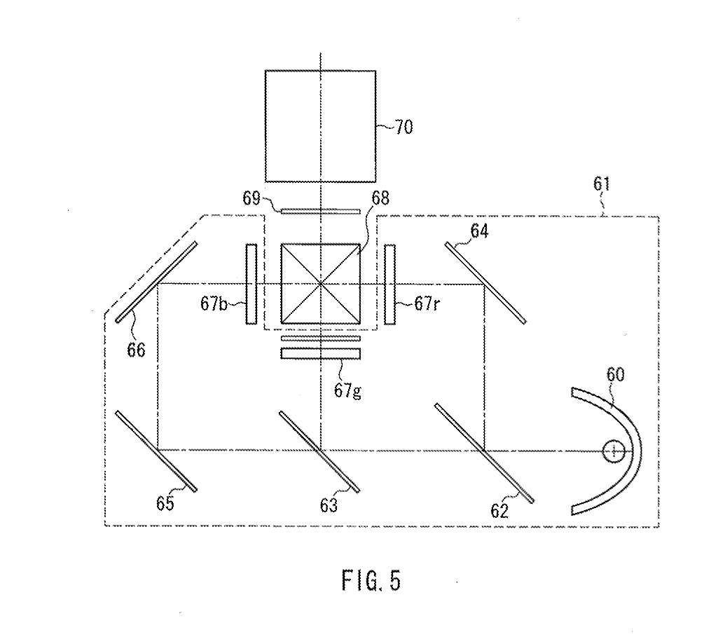

### DETAILED DESCRIPTION OF THE INVENTION

Based on the above-mentioned configuration, the projection display apparatus of the present invention can be embodied as described below.

Namely, it is preferable that the movement control unit operates to move at least the black insertion polarizing elements to the position outside the optical path of the image light in a case of displaying a two-dimensional image.

Also it is possible that the light valve is formed of a liquid crystal light valve, and the projection display apparatus further comprises: a color combining unit that is arranged between the light valve and the projection lens and that combines blue, green and red color lights, and a wavelength-selective polarization rotating element that rotates the polarization direction of a predetermined color light from the color combining unit so as to align the respective polarization directions of the color lights with each other.

Further, it is possible that the black insertion liquid crystal panel is a liquid crystal panel where light-shielding and light transmission are switched by a voltage control.

Further, it is possible that the black insertion polarizing elements are polarizing films mounted on heat-dissipating substrates.

Further, it is possible that the black insertion polarizing elements are inorganic polarizing plates.

Further, it is possible that the movement control unit is capable of electrically controlling the movement.

Further, it is possible that the retardation panel is a liquid crystal cell whose phase difference is switched between zero and a half wavelength by a voltage control.

Further, it is possible that a quarter wave plate is arranged between the retardation panel and the projection lens.

Further, it is possible that the light source is either a discharge lamp or a solid light source.

Hereinafter, embodiments of the present invention will be described with reference to the attached drawings.

### Embodiment 1

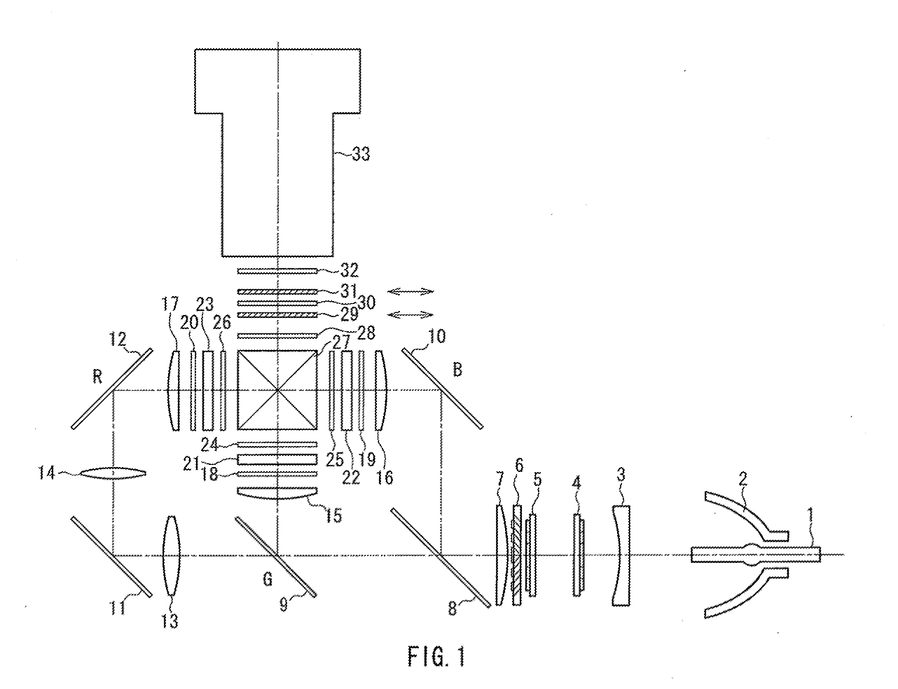

FIG. 1 is a front view showing a configuration of a projection display apparatus in Embodiment 1 of the present invention. In this apparatus, a TN mode or VA mode transmission type liquid crystal panel is used as the liquid crystal light valve.

A light source unit is formed of a discharge lamp 1, a reflection mirror 2 and a concave lens 3. An illumination unit for condensing light from the light source unit and forming illumination light is formed of first and second lens array plates 4, 5, a polarization converting optical element 6, and a condensing lens 7. A color separating unit that separates the illumination light into red, blue and green color lights is formed of a blue reflection dichroic mirror 8, a green reflection dichroic mirror 9, reflection mirrors 10, 11, 12, and relay lenses 13, 14. A light valve unit that forms image lights of the respective color lights obtained by the color-separation is formed of field lenses 15, 16, 17, incident-side polarizing plates 18, 19, 20, image formation liquid crystal panels 21, 22, 23, and emission-side polarizing plates 24, 25, 26.

A color combining prism 27 that combines the image lights of respective colors formed by the light valve unit is formed of a red reflection dichroic mirror and a blue reflection dichroic mirror. The thus combined image lights are adjusted by the wavelength-selective polarization rotating element 28 so that the polarization directions are aligned with each other. A black-insertion unit, which inserts a light-shielding period into the image light emitted from the wavelength-selective polarization rotating element 28, is formed of polarizing plates 29, 31, and a black insertion liquid crystal panel 30. An image light emitted from the black-insertion unit is switched in the polarization direction by the retardation panel 32, and then magnified and projected by the projection lens 33.

Operations of the above-mentioned configuration are described below in detail. A light emitted from the discharge lamp 1 is condensed by the reflection mirror 2, and converted into a substantially parallel light by the concave lens 3. The light converted into a substantially parallel light enters the first lens array plate 4 formed of a plurality of lens elements. The light flux that has entered the first lens array plate 4 is divided into a large number of light fluxes. The divided large number of light fluxes are converged onto the second lens array plate 5 formed of a plurality of lenses. Each lens element of the first lens array plate 4 has an aperture shape that is similar to the shape of the liquid crystal panels, and the focal length is determined such that the first lens array plate 4 and the liquid crystal panels 21, 22, and 23 are substantially in a conjugate relationship. The light that exits from the second lens array plate 5 enters the polarization converting element 6. The polarization converting element 6 is formed of a polarized light separating prism and a half wave plate, and converts natural light from the lamp into a light having one polarization direction. The light from the polarization converting element 6 enters the condensing lens 7. The condensing lens 7 condenses the light exiting from the respective lens elements of the second lens array plate 5 so as to illuminate the liquid crystal panels 21, 22, 23 with a light obtained by superimposing lights from the respective lens elements.

A light exiting from the condensing lens 7 is separated into blue, green, and red color lights by the blue reflection dichroic mirror 8 and the green reflection dichroic mirror 9 that constitute a color separating unit. The green color light passes through the field lens 15 and the incident-side polarizing plate 18, and enters the liquid crystal panel 21. The blue color light is reflected by the reflection mirror 10, thereafter passes through the field lens 16 and the incident-side polarizing plate 19, and enters the liquid crystal panel 22. The red color light is transmitted and refracted by the relay lenses 13 and 14, reflected by the reflection mirrors 11 and 12, then passes through the field lens 17 and the incident-side polarizing plate 20, and enters the liquid crystal panel 23.

The three liquid crystal panels 21, 22, and 23 are constituted using an active matrix system, and they change the polarization state of the incident light in accordance with the control of the voltage applied to pixels according to a video signal. The incident-side polarizing plates 18, 19, 20 and the emission-side polarizing plates 24, 25, and 26 are arranged on both sides of the liquid crystal panel 21, 22, and 23 respectively, such that the transmission axes are orthogonal to each other, thereby modulating the light by an action generated due to the combination. At that time, green, blue, and red image lights for the right eye and for the left eye are formed by time division.

The respective color lights that have passed through the emission-side polarizing plates 24, 25, and 26 are combined by the color combining prism 27. Namely, red color light and blue color light are reflected respectively by the red reflection dichroic mirror and the blue reflection dichroic mirror, and combined with a passing green color light. The green color light in a p-polarized light state passes through the reflection surface of the combining prism 27, while the red and blue color lights in a s-polarized light state are reflected. The reason for using the green color light in the p-polarized light state, and the blue and red color light in the s-polarized light state is because transmittance or reflectance can be increased in a wide range due to the spectral characteristics with respect to respective color lights.

The wavelength-selective polarization rotating element 28 rotates the polarization direction of green color light by 90°, and does not rotate the polarization directions of red and blue color lights. The wavelength-selective polarization rotating element 28 is constituted by laminating a retardation film so as to have a function of rotating the polarization direction of the light in a specified wavelength band. Accordingly, the polarization directions of green, blue, and red color lights will be aligned with the s-polarized light direction. The light that exited from the wavelength-selective polarization rotating element 28 enters the black insertion liquid crystal panel 30 having polarizing plates 29, 31 arranged on the both sides. The black insertion liquid crystal panel 30 shields lights for a predetermined period of the respective image lights for the right eye and for the left eye by a voltage control. The light that has passed through the black insertion liquid crystal panel 30 enters the retardation panel 32. In the retardation panel 32, the phase difference changes to zero or a half wavelength due to the voltage control, thereby rotating the polarization direction of light for a predetermined period.

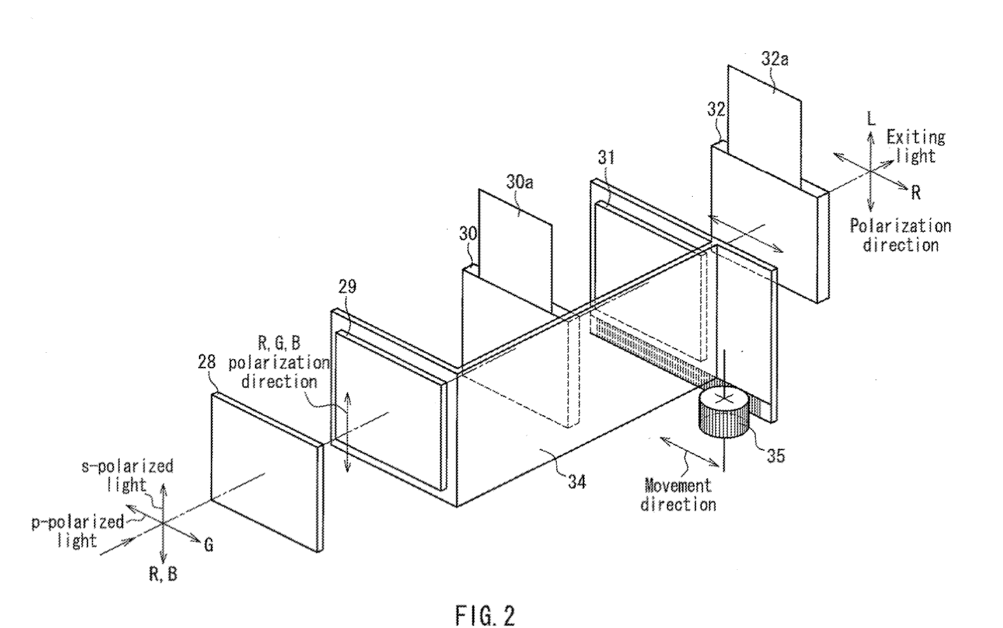

FIG. 2 shows an arrangement of the black insertion liquid crystal panel 30 and the retardation panel 32 and the polarization state therein. In the drawing, flexible wiring boards 30a, 30b for feeding drive signals are illustrated respectively, while wirings with the other members are not shown. Regarding the light from the color combining prism 27, the green color light (G) is the p-polarized light, and the blue and red color lights (R, B) are s-polarized lights. The polarization direction of the green color light is rotated by 90° by the wavelength-selective polarization rotating element 28, so that the green, red and blue color lights are aligned as the s-polarized light. The polarization-transmission axis of the polarizing plate 29 is in the s-polarized light direction. The polarizing plate 31 is arranged as crossed nicols with respect to the polarizing plate 29. The polarizing plates 29, 31 can be constituted by sticking polarizing films on a thin-plate heat-dissipating substrate of sapphire, crystal and the like. The polarization direction of exiting light controlled by the retardation panel 32 is shown as R for the image light for the right eye and as L for the image light for the left eye.

The polarizing plates 29, 31 are held by a holding mechanism 34. The movement of the holding mechanism 34 can be controlled by a gear motor 35. The polarizing plates 29, 31 can be moved to a position outside the optical path by a movement control unit formed of the holding mechanism 34 and the gear motor 35. It should be noted however, that the movement control unit is not always required to be electromotive, but it can be moved by hand. In a case of feeding two-dimensional image signals, the polarizing plates 29, 31 are controlled by gear motor 35 so as to move to a position outside the optical path of the image light.

Since the polarizing plates 29, 31 include heat-dissipating substrates, they dissipate the absorbed heat efficiently. However, the light absorption is large in the polarizing plate 31 since the plate may shield light, while the light absorption is minimized in the polarizing plate 29 since the polarization transmission axis thereof is aligned with the incident light. The polarizing plates 29, 31, the black insertion liquid crystal panel 30, and the retardation panel 32 are cooled respectively by a cooling unit (not shown) depending on the temperature rise, so that the temperature is maintained to not exceed a certain level. When the quantity of light to be absorbed by the polarizing plates 29, 31 is too great and the heat-dissipating substrates cannot suppress the temperature rise at or below a predetermined level, a wire-grid type inorganic polarizing plate or an inorganic polarizing plate prepared by blending stretch-anisotropic metal particles in a glass substrate can be used, though the production cost will be increased.

As mentioned above, from the retardation panel 32, a light, which includes an image light R for the right eye and an image light L for the left eye different from each other in the polarization direction and switched at a predetermined time intervals, is emitted. The black insertion liquid crystal panel 30 and the retardation panel 32 may be of any liquid crystal mode such as STN, TN, OCB, and ferroelectric liquid crystal as long as the liquid crystal is a high-speed liquid crystal having a response speed of not more than 2 ms. As shown in FIG. 1, a light exiting from the retardation panel 32 enters the projection lens 33. The image light R for the right eye and the image light L for the left eye entering the projection lens 33 are magnified and projected on a screen (not shown) that maintains polarization characteristics, without the polarization state being disturbed. The magnified and projected image can be observed as a stereoscopic image through passive system polarization glasses.

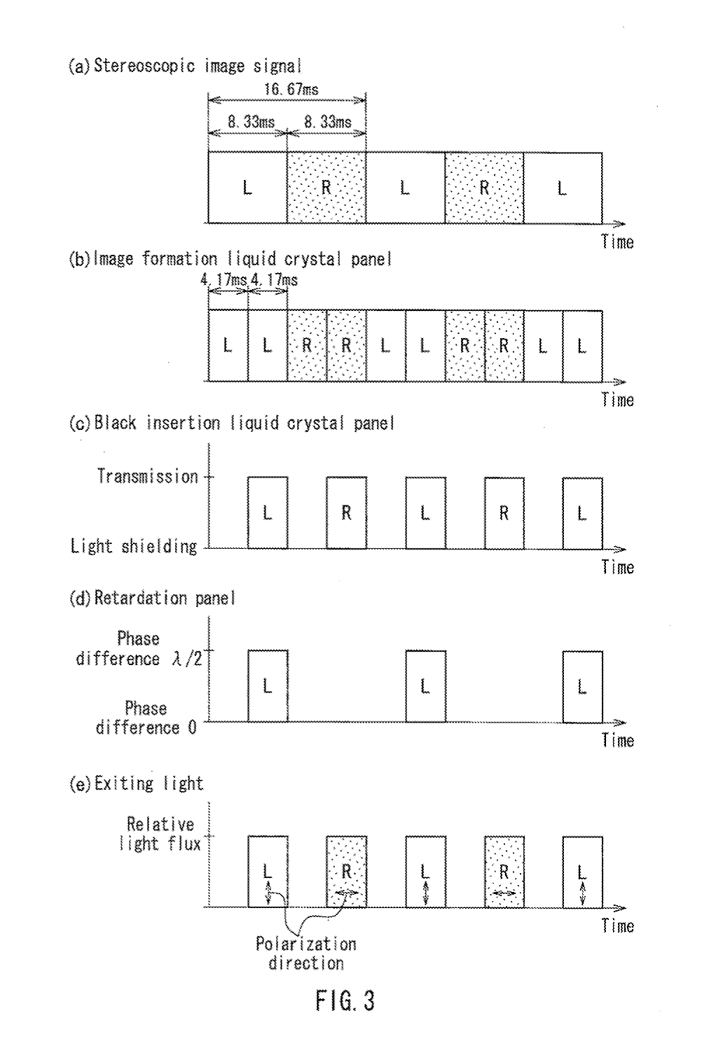

With reference to FIG. 3, operations over time of the black insertion liquid crystal panel 30 and the retardation panel 32 will be mentioned. FIG. 3(a) shows changes of the stereoscopic image signal. FIGS. 3(b)-3(d) show respective changes over time in operations of the image formation liquid crystal panels 18-20, the black insertion liquid crystal panel 30, and the retardation panel 32. FIG. 3(e) shows a change over time in the relative light flux and the polarization direction of the light emitted from the retardation panel 32. In FIG. 3, L and R represent correspondences respectively to the image light L for the left eye and the image light R for the right eye.

The image light signal L for the left eye and the image light R signal for the right eye are time division signals of 60 Hz. The image formation liquid crystal panels 18-20 form the image lights L, R respectively repeating twice at 240 Hz. The black insertion liquid crystal panel 30 is controlled to being transmission state only during the second period of image lights L, R, while it is in a light-shielding state during the other periods. In this manner, the exiting light of the image light for the right eye and the image light for the left eye are separated favorably for every polarization direction, and a light with considerably decreased cross talk is provided.

In an example of typical optical characteristics for respective elements, the polarization-rotation rate of the wavelength-selective polarization rotating element 28 is set to 92%, the polarized light transmittance of the polarizing plates 29, 31 is set to 84%, the transmittances of the black insertion liquid crystal panel 30 and the retardation panel 32 are respectively set to 90%, the aperture time ratio is set to 25%, and the polarized light transmittance of the passive system polarization glasses is set to 84%. In this case, if the wavelength-selective polarization rotating element 28, the black insertion liquid crystal panel 30 and the retardation panel 32 are arranged to obtain a stereoscopic image light, the light use efficiency is 11%.

For the case of liquid crystal shutter glasses, the incident light is natural light. Therefore, if the polarizing plate and the liquid crystal cell have transmittances of similar values, the light use efficiency of the stereoscopic image light will be 7.9%. As a result, in the configuration as shown in FIG. 1, the light use efficiency will be 1.4 times in comparison with a case of using liquid crystal shutter glasses.

In a case of a two-dimensional image, as there is no necessity of maintaining the polarization characteristic, the polarizing plates 29, 31 are moved to a position outside the optical path by the movement control unit. In this case, when the wavelength-selective polarization rotating element 28 has a transmittance of 98% while the black insertion liquid crystal panel 30 and the retardation panel 32 each has a transmittance of 90%, the light use efficiency for the case of two-dimensional image will be 66.7%. In contrast, when the movement of the polarizing plates 29, 31 is not controlled, the light use efficiency will be 44.1%. This comparison indicates that when the movement is controlled, the light use efficiency can be raised to 1.5 times.

In this manner, according to the present embodiment, the light use efficiency is improved and thus a bright stereoscopic image and a bright two-dimensional image can be obtained in comparison with the conventional method.

In a case of two-dimensional image display, when the polarizing plates 29, 31 are moved outside the optical path, the back focus of the projection lens 33 as shown in FIG. 1 changes. When a single polarizing plate has a thickness of 0.7 mm and a refractive index of 1.5, the field displacement will be 0.47 mm. The projection lens 33 is configured to be capable of adjusting such field displacement. Since the polarizing plates 29, 31 are thin plates, the back focus adjustment amount of the projection lens 33 is small. Further, since the polarizing plates 29, 31 do not require wirings for control unlike the liquid crystal panel or a retardation panel, such a simple movement mechanism can be employed.

It is possible to dispose a quarter wave plate that converts linearly-polarized light to circularly-polarized light, between the retardation panel 32 and the projection lens 33. Linearly polarized lights that are orthogonal to each other respectively are converted into clockwise circularly polarized light and counter-clockwise circularly polarized light by the quarter wave plate, and if polarization glasses using a circular polarization system are utilized, it is possible to reduce cross talk that occurs due to the difference in polarization direction angles between the image light and the polarization glasses.

In the above-description, the retardation panel 32 is composed of a liquid crystal cell that switches the phase difference between zero and a half wavelength. Alternatively, the retardation panel can be formed of a liquid crystal cell that switches the phase difference between a quarter wavelength and a ¾ wavelength. In this case, the polarized light will be converted to a circularly-polarized light different in the circumferential direction, and thus polarization glasses of a circular polarization type can be employed without arranging additionally a quarter wave plate.

In FIG. 1, only the movement of the polarizing plates 29, 31 is controlled. This is not a sole example, but the movement of the black insertion liquid crystal panel 30 and the retardation panel 32 can be controlled as well. For this purpose, it is desirable to include in the projection lens 33 a mechanism for the adjustment of the back focus of the projection lens 33 with a significant displacement. By controlling the movement of the black insertion liquid crystal panel 30 and the retardation panel 32, the light use efficiency for a two-dimensional image display can be improved by 23%.

As mentioned above, by use of a wavelength-selective polarization rotating element, a black insertion liquid crystal panel provided with polarizing plates whose movement can be controlled, and a retardation panel, observation by use of practical and inexpensive passive system polarization glasses is available, and thus a bright stereoscopic image display where cross talk is reduced considerably and also a bright two-dimensional image display can be provided.

### Embodiment 2

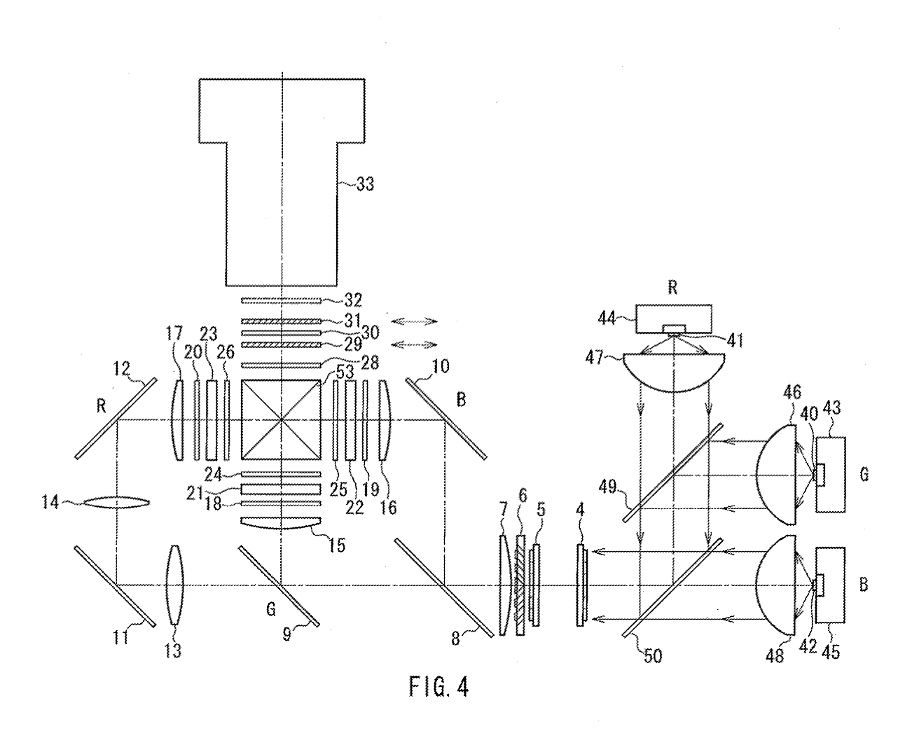

FIG. 4 is a front view showing a configuration of a projection display apparatus according to Embodiment 2 of the present invention. In the apparatus, a TN mode or VA mode transmission-type liquid crystal panel is used for each liquid crystal light valve. For the light source, a light-emitting diode as a solid light source is used. The present embodiment is distinguished from Embodiment 1 in the configuration of the light source unit.

The light source unit is formed of: light-emitting diodes 40, 41, 42 that respectively emit green, red and blue color lights; heat sinks 43, 44, 45; condenser lenses 46, 47, 48; a green reflection dichroic mirror 49; and a blue transmission dichroic mirror 50. Regarding the elements from the first lens array plate 4 of the illumination unit into which light from the light source unit enters to the projection lens 33, the configurations and the operations are similar to those in Embodiment 1. Therefore, common elements are assigned with the same reference numbers in order to avoid duplicated explanation. The configuration and the actions of the light source unit will be described below.

The green, red and blue color lights emitted from the light-emitting diodes 40, 41, 42 are condensed by the respectively corresponding condenser lenses 46, 47, 48 and then converted to a substantially parallel light. The temperatures of the light-emitting diodes 40, 41, 42 are controlled not to be higher than a predetermined point by the heat sinks 43, 44, 45 that are in close-contact with the respective light-emitting diodes and also by an air-cooling unit (not shown).

The green color light from the light-emitting diode 40 is converted to a parallel light and subsequently reflected by the green reflection dichroic mirror 49 and the blue transmission dichroic mirror 50. The red color light from the light-emitting diode 41 passes through the green reflection dichroic mirror 49 and is reflected by the blue transmission dichroic mirror 50. The blue color light from the light-emitting diode 42 passes through the blue transmission dichroic mirror 50. In this manner, the green, red, blue color lights from the light-emitting diodes are combined by the dichroic mirrors 49, 50 so as to make a white light that enters the first lens array plate 4.

The light-emitting diodes have a smaller luminous flux in comparison with a discharge lamp, but they have a long life, a broader color reproduction range, and a higher response speed. In reference to the operation over time in FIG. 3(c) of the black insertion liquid crystal panel 30, the image light is projected on the screen only in the period of 4.17 ms as a timing for transmission. If the light-emitting diodes 40, 41, 42 are turned on to illuminate at this timing, unnecessary light absorption at the black insertion liquid crystal panel 30 does not occur, and the cross talk can be decreased further as well. Since the light-emitting diodes are pulse-driven in use, the luminous flux is greater in comparison with a continuous drive. As a result, the junction temperature of the light-emitting diodes is lowered to allow a long life. The solid light source is not limited to the light-emitting diodes, but similar effects can be obtained even by using a laser light source or a light source that is excited with laser beam so as to fluoresce.

As mentioned in the present embodiment, it is possible to decrease cross talk considerably and to obtain a bright stereoscopic image with a broader color reproduction range by use of a solid light source with a high response speed, a wavelength-selective polarization rotating element, a black insertion liquid crystal panel provided with polarizing plates whose movement can be controlled, and a retardation panel.

As described above, the projection display apparatuses in Embodiments 1 and 2 are configured to convert effectively natural light from a light source to linearly-polarized light, to illuminate the light homogeneously on a liquid crystal panel, and to form an image of green, red and blue color lights by use of three liquid crystal panels of green, red and blue. As a result, it is possible to obtain a bright, homogeneous and high-definition projection image. Furthermore, since a stereoscopic image is displayed with a single projection display apparatus formed of a single projection lens, installation adjustment is not required and a stable projection image can be displayed.

In each of the above Embodiments 1 and 2, a transmission-type liquid crystal panel is used as the liquid crystal light valve. Alternatively, a reflection-type liquid crystal panel can be used. When a reflection type liquid crystal panel is employed, a high definition projection display apparatus can be provided. Furthermore, for the light valve, one or three digital micro-mirror device (DMD) as a mirror-deflection type light valve can be used. When the DMD is used, since the wavelength-selective polarization rotation element is not required and the response speed is increased in comparison with a liquid crystal light valve, the aperture time ratio indicating the transmission state of the black insertion liquid crystal panel can be set to be higher, and thus a small and reliable projection display apparatus can be constituted.

As mentioned above, the projection display apparatus of the present invention can provide a bright stereoscopic image display with a considerably decreased cross talk and also can provide a bright two-dimensional image display, due to a black insertion liquid crystal panel provided with polarizing elements whose movement can be controlled along with a retardation panel. Furthermore, since passive system polarization glasses are used, an inexpensive and practical projection type stereoscopic display apparatus can be configured.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A projection display apparatus comprising:
a light source;
an illumination unit that condenses light from the light source so as to form illumination light;
a light valve that receives the illumination light and forms an image light for the right eye and an image light for the left eye with time division;
a retardation panel that switches polarization directions of the image light for the right eye and the image light for the left eye; and
a projection lens that magnifies and projects the image lights,
thereby displaying the image light for the right eye and the image light for the left eye while differentiating the polarization directions from each other so as to allow observation of a stereoscopic image,
wherein the projection display apparatus further comprises:
a black-insertion unit that comprises a black insertion liquid crystal panel and black insertion polarizing elements arranged on the both sides of the black insertion liquid crystal panel and that is configured to be capable of inserting a light-shielding period between the image light for the right eye and the image light for the left eye by controlling the black insertion liquid crystal panel; and
a movement control unit that moves at least the black insertion polarizing elements between a position in the optical path of the image light and a position outside the optical path.

2. The projection display apparatus according to claim 1, wherein the movement control unit operates to move at least the black insertion polarizing elements to the position outside the optical path of the image light when displaying a two-dimensional image.

3. The projection display apparatus according to claim 1,
wherein the light valve is composed of a liquid crystal light valve, and
the projection display apparatus further comprises:
a color combining unit that is arranged between the light valve and the projection lens and that combines blue, green and red color lights, and
a wavelength-selective polarization rotating element that rotates the polarization direction of a predetermined color light from the color combining unit so as to align the polarization directions of the respective color lights with each other.

4. The projection display apparatus according to claim 1, wherein the black insertion liquid crystal panel is a liquid crystal panel where light-shielding and light transmission are switched by a voltage control.

5. The projection display apparatus according to claim 1, wherein the black insertion polarizing elements are polarizing films mounted on heat-dissipating substrates.

6. The projection display apparatus according to claim 1, wherein the black insertion polarizing elements are inorganic polarizing plates.

7. The projection display apparatus according to claim 2, wherein the movement control unit is capable of electrically controlling the movement.

8. The projection display apparatus according to claim 1, wherein the retardation panel is a liquid crystal cell whose phase difference is switched between zero and a half wavelength by a voltage control.

9. The projection display apparatus according to claim 1, wherein a quarter wave plate is arranged between the retardation panel and the projection lens.

10. The projection display apparatus according to claim 1, wherein the light source is either a discharge lamp or a solid light source.
